(19) United States
(12) Patent Application Publication
(10) Pub. No.: US 2025/0199797 A1
(43) Pub. Date: Jun. 19, 2025

(54) COMMUNICATION DEVICE, NON-TRANSITORY COMPUTER-READABLE RECORDING MEDIUM STORING COMPUTER-READABLE INSTRUCTIONS FOR COMMUNICATION DEVICE, AND METHOD EXECUTED BY COMMUNICATION DEVICE

(71) Applicant: BROTHER KOGYO KABUSHIKI KAISHA, Nagoya (JP)

(72) Inventor: Kentaro ARAI, Nagoya (JP)

(21) Appl. No.: 18/982,157

(22) Filed: Dec. 16, 2024

(30) Foreign Application Priority Data
Dec. 18, 2023 (JP) 2023-212759

(51) Int. Cl. G06F 8/65

(52) U.S. Cl. CPC G06F 8/65

(57) ABSTRACT

A communication device may include a controller. The controller may be configured to: receive, from a server, firmware including a plurality of partial programs and priority information indicating priorities of the plurality of partial programs, wherein the plurality of partial programs includes a first partial program having a high priority and a second partial program having a lower priority than the first partial program; update a program of the communication device by using the first partial program; determine whether an update condition for updating the program of the communication device is satisfied, wherein the update condition is a condition for updating the program of the communication device by using the second partial program; and in a case where it is determined that the update condition is satisfied, update the program of the communication device by using the second partial program.

### REFERENCE TO RELATED APPLICATION

This application claims priority to Japanese Patent Application No. 2023-212759 filed on Dec. 18, 2023. The entire content of the priority application is incorporated herein by reference.

### BACKGROUND ART

A network system including a plurality of information processing devices is known. In this technology, when a first information processing device encounters a DOS attack, the other information processing devices change their port numbers corresponding to specific programs used to communicate with the first information processing device in order to prevent the Dos attack.

### SUMMARY

In order to address attacks from external devices such as DOS attack, it is generally desirable to promptly update a program of a communication device. The disclosure herein provides a novel technology for updating a program of a communication device.

A communication device disclosed herein may comprise a controller. The controller may be configured to: receive, from a server, firmware including a plurality of partial programs and priority information indicating priorities of the plurality of partial programs, wherein the plurality of partial programs includes a first partial program having a high priority indicated by the priority information and a second partial program having a lower priority than the first partial program indicated by the priority information; update a program of the communication device by using the first partial program; after the program of the communication device has been updated by using the first partial program, determine whether an update condition for updating the program of the communication device is satisfied, wherein the update condition is a condition for updating the program of the communication device by using the second partial program; and in a case where it is determined that the update condition is satisfied, update the program of the communication device by using the second partial program.

According to the configuration above, after updating the program of the communication device by using the first partial program having a high priority, the communication device updates the program by using the second partial program having a lower priority in response to the update condition for updating the program of the communication device by using the second partial program being satisfied. Thus, the communication device can use the first and second partial programs in an appropriate order to update the program.

Computer-readable instructions for implementing the above communication device, a non-transitory computer-readable recording medium storing the computer-readable instructions, and a method executed by the above communication device are also novel and useful.

### BRIEF DESCRIPTION OF DRAWINGS

FIG. 1 shows a configuration of a communication system.

FIG. 2 shows contents of tables.

FIG. 3 shows a sequence diagram according to an embodiment.

FIG. 4 shows a sequence diagram continued from FIG. 3.

### DESCRIPTION

### First Embodiment

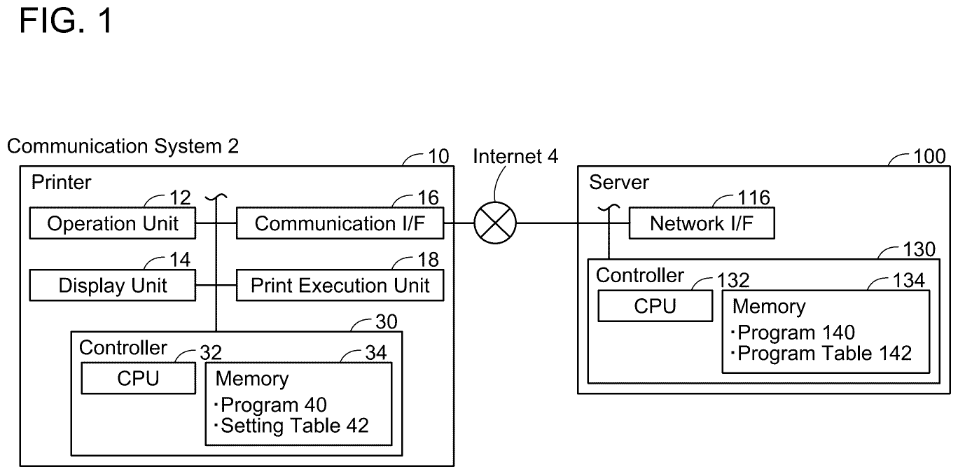

### Configuration of Communication System 2: FIG. 1

As shown in FIG. 1, a communication system 2 comprises a printer 10 and a server 100. The printer 10 and the server 100 are communicable with each other via the internet 4.

### Configuration of Printer 10

The printer 10 is a peripheral device (e.g., a peripheral device of a terminal (not shown)) configured to execute a print function. The printer 10 comprises an operation unit 12, a display unit 14, a communication interface 16, a print execution unit 18, and a controller 30. Hereinafter, an interface is abbreviated as “I/F”.

The operation unit 12 comprises a plurality of keys. A user can input various instructions to the printer 10 by operating the operation unit 12. The display unit 14 is a display configured to display various information. The display unit 14 also functions as a so-called touch screen (i.e., an operation unit). The communication I/F 16 is connected to the internet 4. The communication I/F 16 may be a wireless I/F or a wired I/F. The print execution unit 18 comprises a print mechanism of inkjet scheme, laser scheme, or the like.

The controller 30 comprises a CPU 32 and a memory 34. The memory 34 comprises a main storage and an auxiliary storage, which are not shown. The CPU 32 is configured to execute various processes according to a program 40 stored in the auxiliary storage of the memory 34. Specifically, the CPU 32 loads the program 40 from the auxiliary storage to the main storage and executes the program 40 to execute the various processes. The main storage is for example a RAM and a cache memory. The auxiliary storage may be for example a flash memory, an SSD (solid state drive), a ROM, or a combination thereof. The memory 34 further stores a setting table 42.

### Configuration of Server 100

The server 100 is established on the internet 4 by the vendor of the printer 10. In a modification, the server 100 may be established on the internet 4 by a business operator different from the vendor. In another modification, the vendor of the printer 10 need not prepare hardware for the server 100 and may use an environment provided by an external cloud computing service. In this case, the vendor of the printer 10 may prepare a program (i.e., software) for the server 100 and introduce it to the above-mentioned environment to implement the server 100.

The server 100 comprises a communication I/F 116 and a controller 130. The communication I/F 116 is connected to the internet 4. The controller 130 comprises a CPU 132 and a memory 134. The CPU 132 is configured to execute various processes according to a program 140 stored in the memory 134. The memory 134 is configured of a volatile memory, a non-volatile memory, etc. The memory 134 further stores a program table 142.

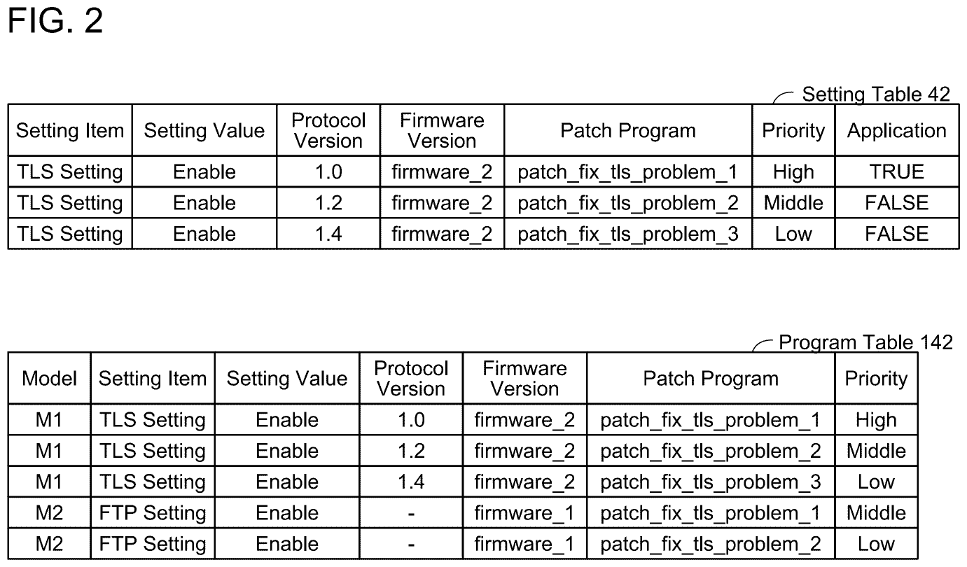

### Contents of Tables: FIG. 2

Referring to FIG. 2, contents of the tables 42 and 142 stored in the printer 10 and the server 100, respectively are described.

In the setting table 42 stored in the printer 10, setting items (e.g., “TLS (transport layer security) setting”), setting values (e.g., “Enable”), protocol versions (e.g., “1.0”, “1.2”), firmware versions (e.g., “firmware_2”), patch programs (e.g., “patch_fix_tls_problem_1”, “patch_fix_tls_problem_2”, “patch_fix_tls_problem_3”), priorities (e.g., “high”, “middle”, “low”), and application information (e.g., “TRUE”, “FALSE”) are stored in association with each other. Hereinafter, “patch_fix_tls_problem” is abbreviated as “pftp”.

Each setting item is information for identifying a setting item related to a communication protocol of the printer 10. Each setting value indicates whether the communication protocol is used or not. A setting value “Enable” indicates that the communication protocol is used, while a setting value “Disable” indicates that the communication protocol is not used. Each protocol version indicates a version of the communication protocol. Each firmware version indicates a version of firmware. Each patch program indicates a specific patch program. The patch programs are partial programs constituting firmware and include for example programs for addressing external attacks to the printer (i.e., vulnerabilities of the printer), programs for improving convenience of the printer, etc.

Each priority indicates a priority of a patch program. A priority “high” is the highest priority, a priority “middle” is the second-highest priority, and a priority “low” is the lowest priority. The priorities “high” and “middle” are assigned to patch programs for addressing vulnerabilities of the printer. For example, vulnerabilities of the printer may be determined based on severity levels calculated by the CVSS (common vulnerability scoring system), although this need not be the case. For example, the priority “high” is assigned where the target vulnerability severity score is 5.0 or more, while the priority “middle” is assigned where the target vulnerability severity score is 4.9 or less. The priority “low” is assigned to for example patch programs for improving the convenience of the printer, such as for adding functions, for extending printer functions, etc. In other words, the priority “low” is assigned to patch programs that are not for addressing vulnerabilities of the printer.

Each priority is information that is used for the printer to determine when its program is to be updated. Patch programs associated with the priority “high” are programs for addressing vulnerabilities with relatively high severities. Thus, immediately after receiving firmware including such a patch program and the priority “high” from the server 100, the printer updates its program by using the patch program. Here, “updating its program by using a patch program immediately after receiving the patch program” may include for example “updating its program by using a patch program within a few minutes (e.g., within one minute) from the receipt of the patch program” or “updating its program by using a patch program after the receipt of the patch program without the printer executing a print process between the receipt and the update”. Patch programs associated with the priority “middle” are patch programs for addressing vulnerabilities with relatively low severities. Thus, the printer updates its program by using such a patch program in a weekly update process which is executed once a week (e.g., on Monday). Patch programs associated with the priority “low” are not for addressing vulnerabilities. Thus, the printer updates its program by using such a patch program in a monthly update process which is executed once a month (e.g., on the last day of the month).

Each application information indicates a value related to whether the printer 10 has applied a patch program or not. Application information “TRUE” indicates that a patch program has been applied, while application information “FALSE” indicates that a patch program has not been applied.

In the program table 142 stored in the server 100, models (e.g., “M1”, “M2”), setting items, setting values, protocol versions, firmware versions, patch programs, and priorities are stored in association with each other. Each model indicates a model name of a printer. Every time vendors of printers develop patch programs, they register the patch programs in the program table 142. Upon the registration, the vendors assign priorities to the patch programs considering severities of vulnerabilities, etc.

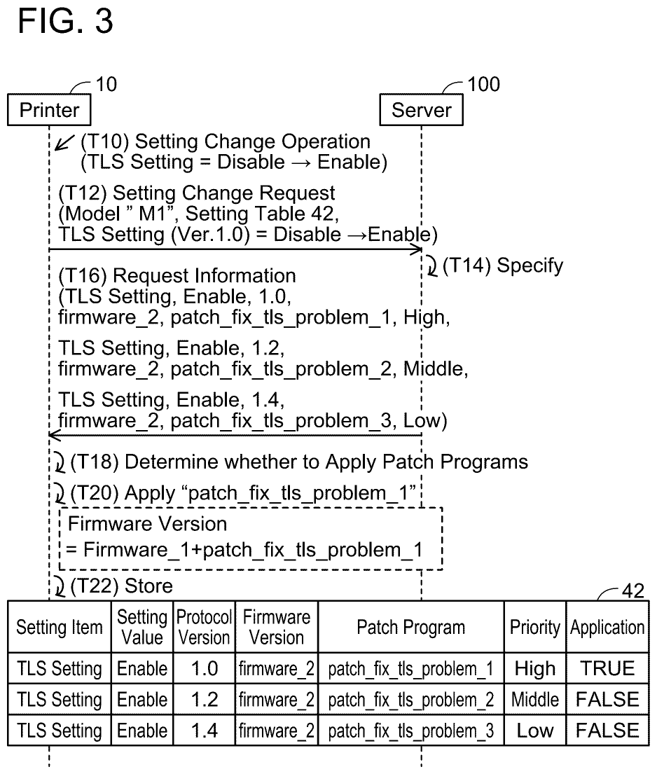

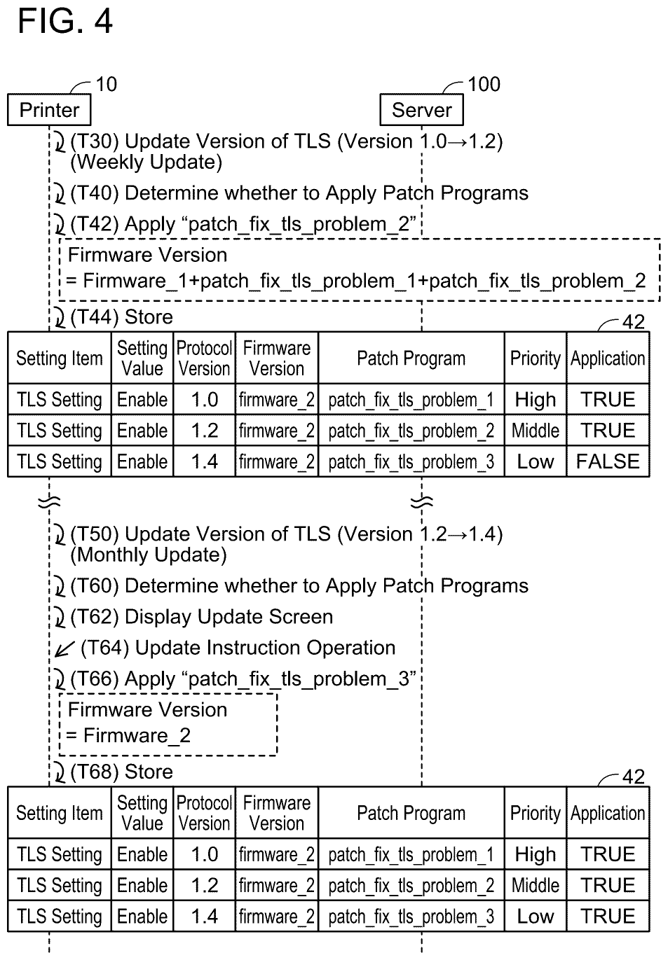

### Specific Process: FIGS. 3 and 4

Referring to FIGS. 3 and 4, a process for updating the program of the printer 10 is described. Hereinafter, to aid understanding, actions executed by the CPU 32 of the printer 10 and the CPU 132 of the server 100 according to the programs 40, 140 are described with the printer 10 and the server 100 as the subjects of the actions, instead of described with the CPUs 32, 132 as the subjects of the actions. In the following description, all communications executed by the printer 10 and the server 100 are via the communication I/Fs 16, 116. Thus, in the following description, a phrase “via the communication I/F 16 (or 116)” is omitted.

In the initial state of the process shown in FIG. 3, the setting table 42 in the printer 10 stores no information, the firmware version of the program 40 in the printer 10 is “Firmware_1”, and the version of communication protocol TLS in the printer 10 is 1.0.

In T10, the printer 10 receives from the user a setting change operation for changing the setting value of TLS setting from “Disable” to “Enable”. In response, in T12, the printer 10 sends the server 100 a setting change request including a model name “M1” of the printer 10, the setting table 42 in which no information is stored yet, the current TLS version “1.0”, and change information indicating that the setting value of TLS setting has been changed from “Disable” to “Enable”.

In response to receiving the setting change request from the printer 10 in T12, the server 100 specifies, in the program table 142, each information associated with the model “M1” (i.e., a setting item, setting value, protocol version, firmware version, patch program, and priority) in T14. In other words, this means specifying firmware for the printer 10 with the model name “M1”. In the program table 142, three sets of information are stored in association with the model “M1”. Specifically, a first set of information includes a setting item “TLS setting”, the setting value “Enable”, a protocol version “1.0”, a firmware version “firmware_2”, a patch program “pftp1”, and the priority “high”; a second set of information includes the setting item “TLS setting”, the setting value “Enable”, a protocol version “1.2”, the firmware version “firmware_2”, a patch program “pftp2”, and the priority “middle”; a third set of information includes the setting item “TLS setting”, the setting value “Enable”, a protocol version “1.4”, the firmware version “firmware_2”, a patch program “pftp3”, and the priority “low”. Thus, firmware specified based on the firmware version “firmware_2” is a set of patch programs including the three patch programs, namely the patch program “pftp1” associated with the priority “high”, the patch program “pftp2” associated with the priority “middle”, and the patch program “pftp3” associated with the priority “low”. In T16, the server 100 sends request information including the specified three sets of information to the printer 10.

In response to receiving the request information from the server 100 in T16, the printer 10 specifies in T18 the set of information including the priority “high” among the three sets of information included in the request information. Then, the printer 10 determines whether the application information associated with the patch program “pftp1” included in the specified set of information indicates “FALSE” in the setting table 42. In the present case, the printer 10 determines that the application information indicates “FALSE” and then continues the process. If, on the other hand, the printer 10 determines that the application information indicates “TRUE”, it does not continue the process.

The printer 10 determines whether the setting item “TLS setting”, the setting value “Enable”, and the protocol version “1.0” included in the specified set of information match the current TLS state in the printer 10. In the present case, the printer 10 determines that they match the current TLS state in the printer 10, and then applies the patch program “pftp1” included in the specified set of information in T20. Here, “applying the patch program ‘pftp1’” means updating the firmware of the program 40 (i.e., version “Firmware_1”) in the printer 10 by using the patch program “pftp1”. The version of firmware of the program 40 is thereby updated to “Firmware_1+pftp1”.

When the printer 10 determines in T18 that the setting item “TLS setting”, the setting value “Enable”, and the protocol version “1.0” included in the specified set of information do not match the current TLS state in the printer 10, the printer 10 does not apply the patch program “pftp1”.

Further, the printer 10 determines that the patch programs “pftp2” and “pftp3” associated with the priorities “middle” and “low”, respectively in the received three sets of information are to be applied in the weekly update process and the monthly update process, respectively. That is, the printer 10 determines that an update condition for updating the firmware by using these patch programs is not satisfied.

In T22, the printer 10 stores the three sets of information included in the request information received in T16 in the setting table 42. The patch program “pftp1” associated with the priority “high” has been already applied in T20. Thus, the printer 10 stores the application information “TRUE” in association with the patch program “pftp1”. The patch programs “pftp2” and “pftp3” associated with the priorities “middle” and “low”, respectively have not been applied to the program 40 yet. Thus, the printer 10 stores the application information “FALSE” in association with each of the patch programs “pftp2” and “pftp3”.

Thereafter, the printer 10 updates the version of TLS from 1.0 to 1.2 in T30 of FIG. 4 and then executes the weekly update process at a predetermined time. The weekly update process is automatically executed without the user performing any operations. Specifically, the printer 10 first specifies in the setting table 42 the set of information including the priority “middle” and the application information “FALSE”. In T40, the printer 10 then determines whether the setting item “TLS setting”, the setting value “Enable”, and the protocol version “1.2” included in the specified set of information match the current TLS state in the printer 10. In the present case, the printer 10 determines that they match the current TLS state in the printer 10, and then applies the patch program “pftp2” included in the specified set of information in T42. The version of the firmware of the program 40 is thereby updated to “Firmware_1+pftp1+pftp2”.

When the printer 10 determines in T40 that the setting item “TLS setting”, the setting value “Enable”, and the protocol version “1.2” included in the specified set of information do not match the current TLS state in the printer 10, the printer 10 does not apply the patch program “pftp2”.

Further, the printer 10 determines that the patch program “pftp3” associated with the priority “low” is to be applied in the monthly update process. That is, the printer 10 determines that an update condition for updating the firmware by using the patch program is not satisfied.

After applying the patch program “pftp2”, in T44 the printer 10 stores the application information “TRUE” in association with the patch program “pftp2” in place of the application information “FALSE” in the setting table 42.

Thereafter, the printer 10 updates the version of TLS from 1.2 to 1.4 in T50, and then executes the monthly update process at a predetermined time. Specifically, the printer 10 first specifies in the setting table 42 the set of information including the priority “low” and the application information “FALSE”. In T60, the printer 10 determines whether the setting item “TLS setting”, the setting value “Enable”, and the protocol version “1.4” included in the specified set of information match the current TLS state in the printer 10. In the present case, the printer 10 determines that they match the current TLS state in the printer 10, and then displays an update screen on the display unit 14 in T62. The update screen includes a message that asks the user whether the patch program “pftp3” included in the specified set of information should be applied or not.

In response to receiving an update operation from the user in T64, the printer 10 applies the patch program “pftp3” in T66. Since all the patch programs “pftp1”, “pftp2”, and “pftp3” included in “Firmware_2” have been applied, the version of the firmware of the program 40 has been updated to “Firmware_2”.

When the printer 10 determines in T60 that the setting item “TLS setting”, the setting value “Enable”, and the protocol version “1.4” included in the specified set of information do not match the current TLS state in the printer 10, the printer 10 does not apply the patch program “pftp3”.

After applying the patch program, the printer 10 stores in the setting table 42 the application information “TRUE” in association with the patch program “pftp3” in place of the application information “FALSE” in T68.

### Advantageous Effects of Embodiment

Generally, a user is prevented from using a printer while firmware of the printer is being updated. The user performing the setting change operation in T10 of FIG. 3 means that the user is probably going to use the printer 10 (e.g., is probably going to cause the print execution unit 18 to execute printing after performing the setting change operation). After the setting change operation has been performed, the printer 10 receives from the server 100 the firmware including the patch program “pftp1” with the priority “high”, the patch program “pftp2” with the priority “middle”, and the patch program “pftp3” with the priority “low” (T16), and then immediately after receiving the firmware, the printer 10 updates the program 40 by using the patch program “pftp1” with the priority “high” (T20). At this time, the printer 10 does not update the program 40 by using the other patch programs “pftp2”, “pftp3”. Thus, the time required for the update of the program 40 is relatively short. Therefore, the user is less likely to be prevented from using the printer 10 in the situation where the user is probably going to use the printer 10.

Thereafter, when the time for the weekly update process comes, the printer 10 determines that the update condition for updating the program 40 by using the patch program “pftp2” with the priority “middle” is satisfied and updates the program 40 by using the patch program “pftp2” (T40, T42 in FIG. 4). Since the weekly update process is an automatic update process that does not require any operations by the user, the user is less likely to use the printer during the weekly update process. Thus, the user is less likely to be prevented from using the printer. As above, the printer 10 can use the patch program “pftp1” with the priority “high” and the patch program “pftp2” with the priority “middle” in the appropriate order to update the program 40. Further, since the printer 10 preferentially uses the patch program “pftp1” with a relatively high priority over the patch program “pftp2” with a relatively low priority to update the program 40, a vulnerability with a relatively high severity level can be promptly addressed.

Thereafter, when the time for the monthly update process comes, the printer 10 determines that the update condition for updating the program 40 by using the patch program “pftp3” with the priority “low” is satisfied, and updates the program 40 by using the patch program “pftp3” according to the instruction from the user (T60 to T66 in FIG. 4). Since the printer 10 preferentially uses the patch programs “pftp1” and “pftp2” for addressing vulnerabilities over the patch program “pftp3” which is not for addressing a vulnerability to update the program 40, vulnerabilities can be promptly addressed. The patch program “pftp3” is applied to the printer 10 in response to the user wishing the application of the patch program on the update screen. Thus, the printer 10 can apply the patch program without preventing the user from using the printer, for example after the user finished using the printer. Therefore, the user convenience is improved.

In response to the setting value of TLS being changed, the printer 10 receives from the server 100 the patch programs “pftp1”, “pftp2”, “pftp3” related to TLS setting (T16 in FIG. 3). Thus, the printer 10 can receive the patch programs for addressing vulnerabilities due to the change of the TLS setting value at the appropriate time.

### Correspondence Relationships

The printer 10 is an example of “communication device”. The patch programs “pftp1”, “pftp2”, and “pftp3” are an example of “a plurality of partial programs”. The patch programs “pftp1”, “pftp2”, and “pftp3” are examples of “first partial program”, “second partial program”, and “third partial program”, respectively. The firmware specified by the firmware version “Firmware_2” is an example of “firmware”. The priorities are an example of “priority information”. The priorities “high”, “middle”, and “low” are examples of “priorities”. The priorities “high”, “middle”, and “low” are examples of “highest priority”, “second-highest priority”, and “third-highest priority”, respectively. The application information “Disable” and the application information “Enable” are examples of “first value” and “second value”, respectively. The TLS is an example of “communication protocol”. The time period from the receipt of the setting change request in T12 of FIG. 3 to the execution of the weekly update process in FIG. 4 is an example of “first predetermined time period”. The time period from the receipt of the setting change request in T12 of FIG. 3 to the execution of the monthly update process in FIG. 4 is an example of “second predetermined time period”.

T16, T20 in FIGS. 3, T40 and T42 in FIG. 4 are examples of “receive, from a server, firmware including a plurality of partial programs and priority information”, “update a program of the communication device by using the first partial program”, “determine whether an update condition for updating the program of the communication device is satisfied”, and “update the program of the communication device by using the second partial program”, respectively. T12 in FIG. 3 is an example of “send changed contents of the specific setting value to the server”.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below.

(Modification 1) “Communication protocol” may be FTP (file transfer protocol) or other protocol, instead of TLS.

(Modification 2) Although dependent on a timing when the firmware is received, the time for executing the monthly update process may come before the time for executing the weekly update process. In this case, in a case where a patch program associated with the priority “middle” that has not been applied to the printer 10 yet is in the setting table 42, the printer 10 may apply this patch program in the monthly update process without executing T62 and T64 of FIG. 4, i.e., without receiving the update instruction operation from the user.

(Modification 3) T12 in FIG. 3 may be omitted. In this case, for example, an always-on connection such as an XMPP (extensible messaging and presence protocol) connection may be established between the printer 10 and the server 100, and in a case where firmware including patch programs to be sent to the printer 10 is stored in the server 100, the server 100 may send request information to the printer 10 via the always-on connection in T16. In this modification, “send changed contents of the specific setting value to the server” may be omitted.

(Modification 4) “Specific setting item” may not be related to whether the communication device uses a specific communication protocol or not. For example, “specific setting item” may be related to whether the communication device uses an encryption scheme used for communication or not. In this case, the “first value” may indicate that the communication device uses the encryption scheme, and the “second value” may indicate that the communication device does not use the encryption scheme. For example, “specific setting item” may be an item for registering a device name, IP address, etc. of a device that is permitted to communicate (or prohibited from communicating) with the communication device.

(Modification 5) There may not be the patch program with the priority “high”. That is, there may be only the patch program with the priority “middle” and the patch program with the priority “low”. In this modification, “highest priority” may be omitted. In another modification, there may not be the patch program with the priority “middle”. That is, there may be only the patch program with the priority “high” and the patch program with the priority “low”. In this modification, “second-highest priority” may be omitted. In yet another modification, there may not be the patch program with the priority “low”. That is, there may be only the patch program with the priority “high” and the patch program with the priority “middle”. In this modification, “third-highest priority” may be omitted.

(Modification 6) “Update condition” may include that the state of the printer 10 shifts from a state in which a process is being executed such as a “busy” state to a state in which a process is not being executed such as an “idle state” (e.g., standby state). Generally, “update condition” may not include that the first or second predetermined time period has elapsed from when the firmware and the priority information were received from the server.

(Modification 7) In the embodiment described above, the processes shown in FIGS. 3 and 4 are implemented by software (e.g., the program 40 in the printer 10, the program 140 in the server 100), however, at least one of these processes may be implemented by hardware such as a logic circuit.

What is claimed is:

1. A communication device comprising a controller,
wherein the controller is configured to:
receive, from a server, firmware including a plurality of partial programs and priority information indicating priorities of the plurality of partial programs, wherein the plurality of partial programs includes a first partial program having a high priority indicated by the priority information and a second partial program having a lower priority than the first partial program indicated by the priority information;
update a program of the communication device by using the first partial program;
after the program of the communication device has been updated by using the first partial program, determine whether an update condition for updating the program of the communication device is satisfied, wherein the update condition is a condition for updating the program of the communication device by using the second partial program; and
in a case where it is determined that the update condition is satisfied, update the program of the communication device by using the second partial program.

2. The communication device as in claim 1, wherein
the controller is further configured to:
in a case where a specific setting value corresponding to a specific setting item related to communication is changed from a first value to a second value, send changed contents of the specific setting value to the server,
wherein the firmware including at least one partial program related to the specific setting value and the priority information are received from the server in response to the changed contents being sent to the server.

3. The communication device as in claim 2, wherein
the specific setting item is related to whether the communication device uses a specific communication protocol,
the first value indicates that the communication device does not use the specific communication protocol, and
the second value indicates that the communication device uses the specific communication protocol.

4. The communication device as in claim 3, wherein
the first value indicates that the communication device does not use a predetermined version of the specific communication protocol, and
the second value indicates that the communication device uses the predetermined version of the specific communication protocol.

5. The communication device as in claim 1, wherein
the priority order includes a highest priority and a second-highest priority lower than the highest priority, and
in a case where the first partial program has the highest priority, the program of the communication device is updated by using the first partial program immediately after the firmware and the priority information have been received from the server.

6. The communication device as in claim 5, wherein
the update condition includes that a first predetermined time period elapses from when the firmware and the priority information were received from the server, and
in a case where the second partial program has the second-highest priority, it is determined that the update condition is satisfied in response to the first predetermined time period having elapsed from when the firmware and the priority information were received from the server.

7. The communication device as in claim 6, wherein
the priority order includes the highest priority, the second-highest priority, and a third-highest priority lower than the second-highest priority,
the update condition includes that a second predetermined time period elapses from when the firmware and the priority information were received from the server,
in a case where the second partial program has the third-highest priority, it is determined that the update condition is satisfied in response to the second predetermined time period having elapsed from when the firmware and the priority information were received from the server, and
the second predetermined time period is longer than the first predetermined time period.

8. The communication device as in claim 1, wherein
in the priority information, a partial program for addressing a vulnerability of the communication device has a higher priority than a partial program that is not for addressing a vulnerability of the communication device.

9. The communication device as in claim 1, wherein
in the priority information, a partial program having a higher vulnerability severity score has a higher priority than a partial program having a lower vulnerability severity score.

10. A non-transitory computer-readable storage medium storing computer-readable instructions for a communication device, wherein
the computer-readable instructions, when executed by a processor of the communication device, cause the communication device to:
receive, from a server, firmware including a plurality of partial programs and priority information indicating a priority order of the plurality of partial programs, wherein the plurality of partial programs includes a first partial program having a high priority in the priority order indicated by the priority information and a second partial program having a lower priority than the first partial program in the priority order indicated by the priority information;
update a program of the communication device by using the first partial program;
after the program of the communication device has been updated by using the first partial program, determine whether an update condition for updating the program of the communication device is satisfied, wherein the update condition is a condition for updating the program of the communication device by using the second partial program; and
in a case where it is determined that the update condition is satisfied, update the program of the communication device by using the second partial program.

11. A method executed by a communication device, the method comprising:
receiving, from a server, firmware including a plurality of partial programs and priority information indicating a priority order of the plurality of partial programs, wherein the plurality of partial programs includes a first partial program having a high priority in the priority order indicated by the priority information and a second partial program having a lower priority than the first partial program in the priority order indicated by the priority information;
updating a program of the communication device by using the first partial program;
after the program of the communication device has been updated by using the first partial program, determining whether an update condition for updating the program of the communication device is satisfied, wherein the update condition is a condition for updating the program of the communication device by using the second partial program; and
in a case where it is determined that the update condition is satisfied, updating the program of the communication device by using the second partial program.
